(19) United States
(12) Patent Application Publication
(10) Pub. No.: US 2017/0180717 A1
(43) Pub. Date: Jun. 22, 2017

(54) BILATERAL DISTANCE AUTOMATIC CONTROL DISPLAY APPARATUS PROVIDING A MULTI-FOCUS VIDEO AND METHOD THEREFOR

(71) Applicant: ELECTRONICS AND TELECOMMUNICATIONS RESEARCH INSTITUTE, Daejeon (KR)

(72) Inventors: Beom Ryeol LEE, Daejeon (KR); Jin Ryong KIM, Daejeon (KR); Jeung Chul PARK, Daejeon (KR); Il Kwon JEONG, Daejeon (KR); Gi Su HEO, Jeonju (KR)

(21) Appl. No.: 15/387,577

(22) Filed: Dec. 21, 2016

(30) Foreign Application Priority Data
Dec. 21, 2015 (KR) 10-2015-0183209
Sep. 22, 2016 (KR) 10-2016-0121601

(51) Int. Cl. H04N 13/04

(52) U.S. Cl. CPC H04N 13/0459; H04N 13/0497; H04N 13/0422; G02B 3/08

(57) ABSTRACT

Disclosed herein are a bilateral distance automatic control display apparatus providing super multiview images and a method therefor regardless of a difference in a bilateral distance of a viewer in displaying the super multiview images, in which the bilateral distance automatic control display apparatus may include a projection module and a fresnel lens. The present invention has been made in an effort to provide a bilateral distance automatic control display apparatus providing super multiview images and a method therefor having advantages of visually providing a higher quality of super multiview images to viewer's eyes by widening an observable viewing zone of the super multiview images in a left and right direction when the super multiview images is provided to the viewer by using super multiview images display, thereby providing the environment that the viewer may conveniently experience characteristics of the super multiview images.

### CROSS-REFERENCE TO RELATED APPLICATION

This application claims priority to and the benefit of Korean Patent Application Nos. 10-2015-0183209 and 10-2016-0121601, filed in the Korean Intellectual Property Office on Dec. 21, 2015 and Sep. 22, 2016, respectively, the entire contents of which are incorporated herein by reference.

### BACKGROUND OF THE INVENTION

(a) Field of the Invention

The present invention relates to a technique for generating and providing a super multiview image display, and more particularly, to a bilateral distance automatic control display apparatus providing super multiview images and a method therefor regardless of a difference in a bilateral distance of a viewer in displaying the super multiview images.

(b) Description of the Related Art

Display characteristics of super multiview images are to provide a 3D image in a space without an eye fatigue by radically solving an accommodation-vergence conflict problem of viewer's eyes.

The accommodation-vergence conflict problem of viewer's eyes is caused because a position of a 3D object in a space on which both eyes focus and a position of an object in a space that a viewer feels are different from each other.

A super multiview image display may be output by applying a view image of at least two views to each of viewer's eyes. Under this condition, an effect of extending a depth of field (DoF) of both eyes is generated and thus both eyes directly focus on an object actually recognized in a 3D space. Therefore, a display apparatus for providing super multiview images to a viewer may have a structure of applying two-view images to each of viewer's eyes.

At this point, for a viewer to view super multiview images, both eyes have to be accurately positioned at a position in a space on which the super multiview images focuses, and the related art has a trouble in separately adjusting it.

Because of the trouble, the existing display apparatus has a structure in which the super multiview images may be fixedly provided to both eyes, based on 65 mm that is an average of a bilateral distance of a viewer. However, because there is a difference in a bilateral distance for each person, the existing display apparatus has a difficulty in providing a clear super multiview images to viewer's eyes.

As a method for solving a problem of focal alignment between a view of a viewer and multiview bilateral images in a display apparatus, an eye tracking technology of displaying an image depending on a position of a viewer's eye may be used, which has a limitation in precision, complexity, and cost of a system.

### SUMMARY OF THE INVENTION

The present invention has been made in an effort to provide a bilateral distance automatic control display apparatus providing super multiview images and a method therefor having advantages of visually providing a higher quality of super multiview images to viewer's eyes by widening an observable viewing zone of the super multiview images in a left and right direction when the super multiview images is provided to the viewer by using super multiview images display, thereby providing the environment that the viewer may conveniently experience characteristics of the super multiview images.

An exemplary embodiment of the present invention provides a bilateral distance automatic control display apparatus providing super multiview images, including: a projection module including an RGB projection chip receiving view images of left and right eyes and converting the view images into RGB-based beam images and a shuttering controller receiving each of the converted beam images, controlling shuttering of an LC shutter array according to on timing of the RGB projection chip, and generating the received beam images as each of the super multiview images; and a fresnel lens integrating each of the generated super multiview images into one image, in which the projection module is configured as an individual projection module for left and right eyes and has a symmetric structure for applying each of the two-view images to both eyes.

In a period of the on timing of the RGB projection chip, a maximum period may be determined depending on a maximum shuttering speed of the LC shutter array.

The shuttering controller may include: an RGB projection chip on timing determiner determining the on timing of the RGB projection chip depending on the shuttering speed of the LC shutter array to improve an observation vision in a horizontal direction; a disparity reflector loading corresponding frames one by one in each of the converted beam images and reflecting disparity between the left and right eyes to each of the loaded frames; and a super multiview image provider applying each of the frames, to which the disparity is reflected, to the LC shutter array and shuttering the LC shutter array according to the on timing of the RGB projection chip to generate each of the frames as each of the super multiview images.

The disparity reflector may perform the reflection of the disparity on each of the loaded frames on all the frames of each of the converted beam images.

Another embodiment of the present invention provides a bilateral distance automatic control display method providing super multiview images, including: receiving view images of left and right eyes and converting the view images into RGB-based beam images; receiving each of the converted beam images, controlling shuttering of an LC shutter array according to on timing of the RGB projection chip, and generating the received beam images as each of the super multiview images; and integrating each of the generated super multiview images into one image.

In a period of the on timing of the RGB projection chip, a maximum period may be determined depending on a maximum shuttering speed of the LC shutter array.

The generating of each of the super multiview images may include: determining the on timing of the RGB projection chip depending on the shuttering speed of the LC shutter array to improve an observation vision in a horizontal direction; loading corresponding frames one by one in each of the converted beam images and reflecting disparity between the left and right eyes to each of the loaded frames; and applying each of the frames, to which the disparity is reflected, to the LC shutter array and shuttering the LC shutter array according to the on timing of the RGB projection chip to generate each of the frames as each of the super multiview images.

In the reflecting of the disparity on each of the loaded frames, the reflection of the disparity on each of the loaded frames may be performed on all the frames of each of the beam images.

According to the exemplary embodiment of the present invention, it is possible to simplify the implementation complexity of the super multiview images display apparatus and allow the viewer of the super multiview images to more effectively experience the conditions and characteristics of the super multiview images.

In particular, it is possible to promote the revitalization of the acquisition and creation market of the super multiview images content by identifying the characteristics of the super multiview images display and predict the additional diffusion effect of industries associated with the production of the super multiview images content by suggesting the infrastructure environment for verifying the display fitted in the conditions and characteristics of the super multiview images.

Further, it is possible to contribute to the mass production and the consumption expansion of the super multiview images content by suggesting the more effective new super multiview images display apparatus to the viewer to serve to upgrade the super multiview images display technology to the next level.

Finally, it is possible to greatly contribute to the commercialization of the super multiview images display apparatus by miniaturizing the projection super multiview images display apparatus.

### BRIEF DESCRIPTION OF THE DRAWINGS

FIG. 1 is a configuration diagram of a bilateral distance automatic control display apparatus providing super multiview images according to an exemplary embodiment of the present invention.

FIG. 2 is a diagram illustrating a structure of the bilateral distance automatic control display apparatus providing super multiview images according to the exemplary embodiment of the present invention.

FIG. 3 is a detailed configuration diagram of a shuttering controller illustrated in FIG. 1.

FIG. 4 is a diagram illustrating on/off shuttering of an LC shutter array according to an exemplary embodiment of the present invention.

FIG. 5 is a timing diagram of a shuttering control according to an exemplary embodiment of the present invention.

FIG. 6 is a diagram illustrating switching of a shutter according to an exemplary embodiment of the present invention.

FIG. 7 is a flow chart of a bilateral distance automatic control display method providing super multiview images according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout the specification, unless explicitly described to the contrary, “comprising” any components will be understood to imply the inclusion of other elements rather than the exclusion of any other elements.

Hereinafter, a bilateral distance automatic control display apparatus providing super multiview images and a method therefor according to an exemplary embodiment of the present invention will be described with reference to the accompanying drawings.

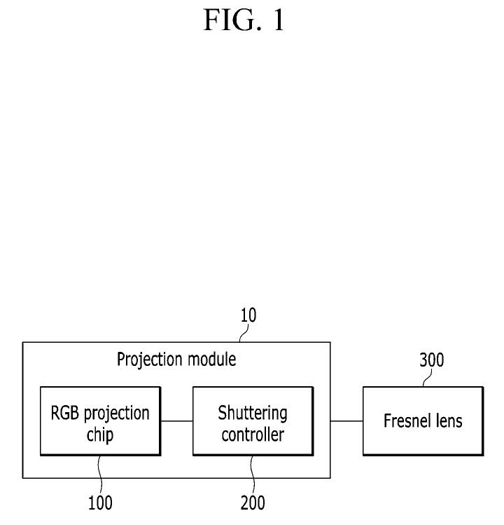

FIG. 1 is a configuration diagram of a bilateral distance automatic control display apparatus 100 providing super multiview images according to an exemplary embodiment of the present invention.

Referring to FIG. 1, the bilateral distance automatic control display apparatus 100 providing super multiview images according to the exemplary embodiment of the present invention may include a projection module 10 and a fresnel lens 200.

The bilateral distance automatic control display apparatus 100 providing super multiview images is configured as individual modules for left and right eyes and may have a symmetric structure to apply two-view images to both eyes, respectively.

The projection module 10 may include an RGB projection chip 100 and a shuttering controller 200.

The RGB projection chip 100 may receive view images of left and right eyes and convert each of the view images into an RGB-based beam image.

The shuttering controller 200 may receive each of the converted beam images, control shuttering of an LC shutter array according to on timing of an RGB projection chip, and generate the received beam images as each of the super multiview images.

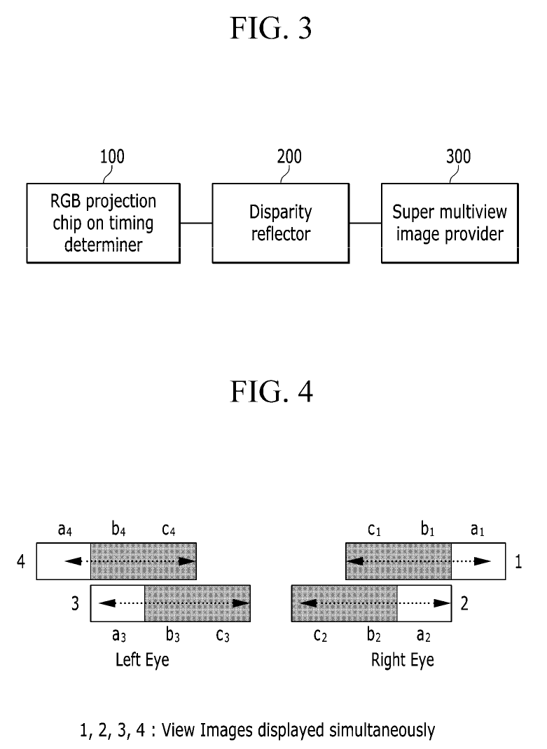

The shuttering controller 200 will be described in more detail with reference to FIG. 3.

According to the exemplary embodiment of the present invention, in a period of the on timing of the RGB projection chip, a maximum period may be determined depending on a maximum shuttering speed of the LC shutter array.

The fresnel lens 300 may integrate each of the generated super multiview images into one image.

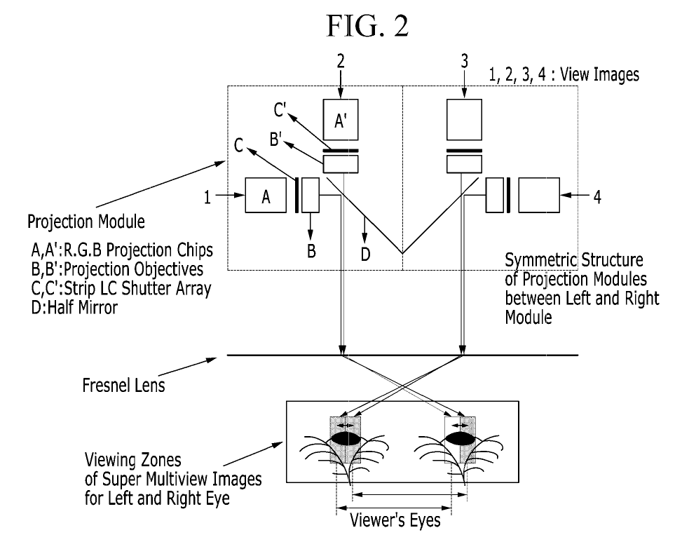

FIG. 2 is a diagram illustrating a structure of the bilateral distance automatic control display apparatus 100 providing super multiview images according to the exemplary embodiment of the present invention.

According to the embodiment of the present invention, a structure of a bilateral distance automatic control display apparatus 1000 for providing super multiview images may include an individual projection module for left and right eyes and have a symmetric structure for applying each of the two-view images to both eyes.

Referring to FIG. 2, each of the projection modules may receive the two-view images and pass the received two-view images through the RGB projection chip and then pass through a half mirror via the LC shutter array and a projection objective to integrate the super multiview images of two views into one image using the fresnel lens.

According to the exemplary embodiment of the present invention, the super multiview images of the space may be received by the viewer to fit a focal distance of the fresnel lens.

According to the exemplary embodiment of the present invention, the on/off control of the LC shutter array may depend on the on timing of the RGB projection.

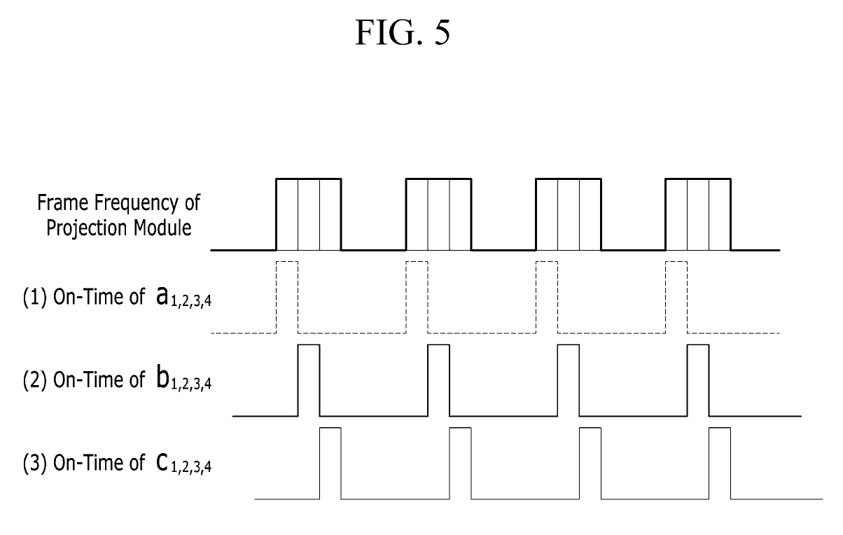

According to the exemplary embodiment of the present invention, the on timing of the RGB projection chip may be determined to be a level enough to permit the shuttering speed of the LC shutter array and according to the exemplary embodiment of FIGS. 4 and 5, the on timing of the RGB projection chip may be determined as being divided into 3.

According to the exemplary embodiment of the present invention, it is possible to provide an effect of expanding an observation vision of a viewer as much as about three times in a horizontal direction.

FIG. 3 is a detailed configuration diagram of the shuttering controller 200 illustrated in FIG. 1.

Referring to FIG. 3, the shuttering controller 200 may include an RGB projection chip on timing determiner 210, a disparity reflector 220, and a super multiview image provider 230.

The RGB projection chip on timing determiner 210 may determine the on timing of the RGB projection chip depending on the shuttering speed of the LC shutter array to improve the observation vision in the horizontal direction.

The disparity reflector 220 may load corresponding frames one by one in each of the converted beam images and reflect the disparity between the left and right eyes to each of the loaded frames.

The super multiview image provider 230 may apply each of the frames, to which the disparity is reflected, to the LC shutter array and shutter the LC shutter array according to the on timing of the RGB projection chip to generate each of the frames as each of the super multiview images.

According to the exemplary embodiment of the present invention, the reflection of the disparity on each of the loaded frames is performed on all the frames of each of the converted beam images and thus the super multiview images may be provided.

FIG. 4 is a diagram illustrating the on/off shuttering of an LC shutter array according to an exemplary embodiment of the present invention.

FIG. 4 illustrates the on/off structure of the LC shutter array provided to the left and right eyes and the on/off shuttering.

Referring to FIGS. 4, 1, 2, 3, and 4 represent the input view images, in which each view image is simultaneously provided to a viewer by shuttering of a shutter strip.

By doing so, it is possible to provide an effect of expanding a vision to be three times wider in a horizontal direction regardless of a difference in a bilateral distance of a viewer.

FIG. 5 is a timing diagram of the shuttering control according to an exemplary embodiment of the present invention.

Referring to FIG. 5, the shutter speed of the LC shutter array is determined by the on shuttering for periods a, b, and c during the on timing of one frame of the projection module as in FIG. 5. At this point, each of the view images 1, 2, 3, and 4 is simultaneously provided to a viewer.

Referring to FIG. 5, according to the exemplary embodiment of the present invention, a frequency of the projection module is 60 Hz and timing of DeletedTextsis divided into three equal parts to expose the view image for periods a, b, and c, such that a viewer may provide the super multiview images extending in a left and right direction.

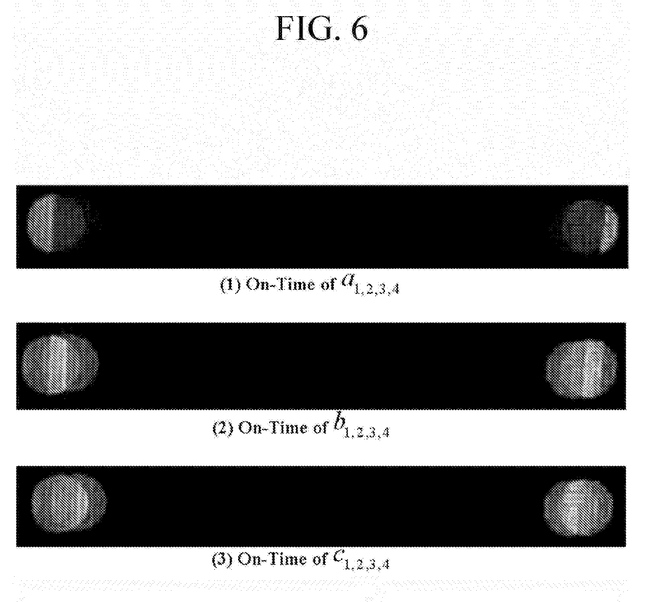

FIG. 6 is a diagram illustrating switching of a shutter according to an exemplary embodiment of the present invention.

FIG. 6 is a diagram illustrating the view image by the switching operation of the shutter of the LC shutter array.

According to the exemplary embodiment of the present invention, it may be appreciated that each of the view images 1, 2, 3, and 4 are provided by exposure times a, b, and c by the shuttering of the LC shutter array.

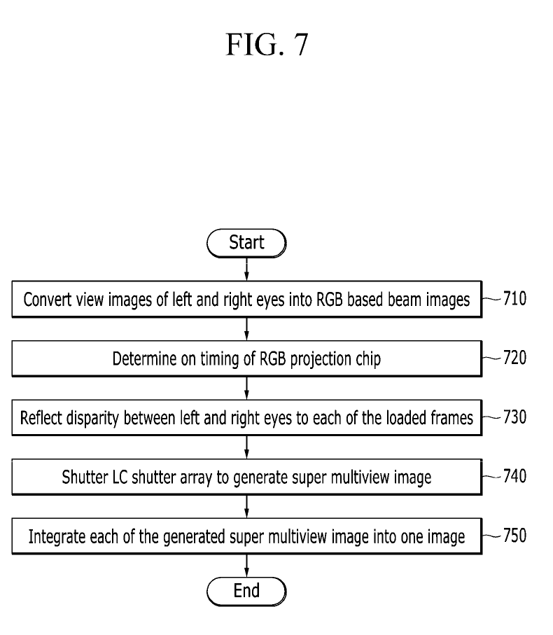

FIG. 7 is a flow chart of a bilateral distance automatic control display method providing super multiview images according to an exemplary embodiment of the present invention.

The view images of the left and right eyes are each converted into the RGB-based beam images DeletedTexts.

According to the exemplary embodiment of the present invention, the view images of the left and right eyes may be received and each may be converted into the RGB-based beam images.

The on timing of the RGB projection chip is determined (720).

According to the exemplary embodiment of the present invention, the on timing of the RGB projection chip may be determined depending on the shuttering speed of the LC shutter array to improve the observation vision in the horizontal direction.

The disparity between the left and right eyes is reflected to each of the loaded frames (730).

According to the exemplary embodiment of the present invention, the corresponding frames may be loaded one by one in each of the converted beam images and the disparity between the left and right eyes may be reflected to each of the loaded frames.

According to the exemplary embodiment of the present invention, the reflection of the disparity on each of the loaded frames is performed on all the frames of each of the converted beam images and thus the super multiview images may be provided.

The super multiview images are generated by shuttering the LC shutter array (740).

According to the exemplary embodiment of the present invention, each of the frames to which the disparity is reflected is applied to the LC shutter array and the LC shutter array according to the on timing of the RGB projection chip may be shuttered to generate each of the frames as each of the super multiview images.

According to the exemplary embodiment of the present invention, in a period of the on timing of the RGB projection chip, a maximum period may be determined depending on a maximum shuttering speed of the LC shutter array.

Each of the generated super multiview images is integrated into one image (750).

According to the exemplary embodiment of the present invention, each of the super multiview images generated by the fresnel lens may be integrated into one image.

The exemplary embodiment of the present invention may not be implemented only by the apparatus and/or the method described above, but while this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A bilateral distance automatic control display apparatus providing super multiview images, comprising:
a projection module including an RGB projection chip receiving view images of left and right eyes and converting the view images into RGB-based beam images and
a shuttering controller receiving each of the converted beam images, controlling shuttering of an LC shutter array according to on timing of the RGB projection chip, and generating the received beam images as each of the super multiview images, and
a fresnel lens integrating each of the generated super multiview images into one image,
wherein the projection module is configured as an individual projection module for left and right eyes and has a symmetric structure for applying each of the two-view images to both eyes.

2. The bilateral distance automatic control display apparatus of claim 1, wherein:
in a period of the on timing of the RGB projection chip, a maximum period is determined depending on a maximum shuttering speed of the LC shutter array.

3. The bilateral distance automatic control display apparatus of claim 1, wherein: the shuttering controller includes:
an RGB projection chip on timing determiner determining the on timing of the RGB projection chip depending on the shuttering speed of the LC shutter array to improve an observation vision in a horizontal direction;
a disparity reflector loading corresponding frames one by one in each of the converted beam images and reflecting disparity between the left and right eyes to each of the loaded frames; and
a super multiview image provider applying each of the frames, to which the disparity is reflected, to the LC shutter array and shuttering the LC shutter array according to the on timing of the RGB projection chip to generate each of the frames as each of the super multiview images.

4. The bilateral distance automatic control display apparatus of claim 3, wherein: the disparity reflector
performs the reflection of the disparity on each of the loaded frames on all the frames of each of the converted beam images.

5. A bilateral distance automatic control display method providing super multiview images, comprising:
receiving view images of left and right eyes and converting the view images into RGB-based beam images;
receiving each of the converted beam images, controlling shuttering of an LC shutter array according to on timing of an RGB projection chip, and generating the received beam images as each of the super multiview images; and
integrating each of the generated super multiview images into one image.

6. The bilateral distance automatic control display method of claim 5, wherein:
in a period of the on timing of the RGB projection chip, a maximum period is determined depending on a maximum shuttering speed of the LC shutter array.

7. The bilateral distance automatic control display method of claim 5, wherein: the generating of each of the super multiview images includes:
determining the on timing of the RGB projection chip depending on the shuttering speed of the LC shutter array to improve an observation vision in a horizontal direction;
loading corresponding frames one by one in each of the converted beam images and reflecting disparity between the left and right eyes to each of the loaded frames; and
applying each of the frames, to which the disparity is reflected, to the LC shutter array and shuttering the LC shutter array according to the on timing of the RGB projection chip to generate each of the frames as each of the super multiview images.

8. The bilateral distance automatic control display method of claim 7, wherein: in the reflecting of the disparity on each of the loaded frames,
the reflection of the disparity on each of the loaded frames is performed on all the frames of each of the beam images.
